(19) United States
(12) Patent Application Publication
(10) Pub. No.: US 2023/0221732 A1
(43) Pub. Date: Jul. 13, 2023

(54) SYSTEMS AND METHODS FOR AUTONOMOUS DRONE FLIGHT CONTROL

(71) Applicant: SENTINEL ADVANCEMENTS, INC., El Paso, TX (US)

(72) Inventors: Juan Humberto Sossa Azuela, Ciudad de Mexico (MX); Manuel de Jesus Nandayapa Alfaro, Juarez Chihuahua (MX); Raul Rojas Gonzalez, Kleinmachnow (DE); Humberto de Jesus Ochoa Dominguez, Chihuahua (MX); Osslan Osiris Vergara Villegas, Chihuahua (MX); Carlos Guillermo Quijas, El Paso, TX (US)

(21) Appl. No.: 17/572,567

(22) Filed: Jan. 10, 2022

(51) Int. Cl. G05D 1/10; G05D 1/00; G07C 5/08; B64C 39/02

(52) U.S. Cl. CPC G05D 1/101; G05D 1/0061; G07C 5/0816; B64C 39/024; B64C 2201/146

(57) ABSTRACT

A method and system for controlling autonomous vehicles comprises a flight controller comprising at least one processor and a computer-usable medium embodying computer program code, the computer-usable medium capable of communicating with at least one processor, the computer program code comprising instructions executable by at least one processor and configured for controlling a vehicle, the flight controller further comprising: an obstacle avoidance module, a state machine, a data link module, and a control computer module.

### TECHNICAL FIELD

Embodiments are generally related to the field of controllers. Embodiments are also related to state machines. Embodiments are further related to the field of autonomous vehicles and drones. Embodiments are also related to methods, systems, and devices for controllers for drones and/or autonomous vehicles. Embodiments are further related to systems and methods for autonomous drone flight controllers based on a state machine.

### BACKGROUND

The advent of autonomous flying vehicles was a significant milestone for all engineers involved in the aerospace field. This has allowed drone deployment in many application domains. For example, drones are now used for commercial missions, surveillance, reconnaissance, mapping, cartography, homeland security, rescue, and remote sensing. Among these, last-mile delivery is becoming one of the most promising applications. The motivation for drones is to make processes faster and more flexible, in addition to improving precision and cost-efficiency.

Vertical takeoff and landing (VTOL) drones require no takeoff or landing run. Hence, they are suitable for applications where the landing area is limited. For example, in commercial missions, VTOL is particularly attractive because the aircraft can hover over the delivery place, land, and/or drop off a package. By contrast, a fixed-wing, conventional takeoff, and landing (CVTOL) drone needs ground infrastructure such as runways and land personal. Therefore, their configuration makes them suitable for long-range, high-capacity applications. However, they have poor hover-ability.

Currently, some drones are equipped with integrated mechanisms for specifying and executing low level reactive control tasks. This is the solution going from one control mode to another. For example, before switching between hovering mode and flight-to-mission mode, the attitude and the alignment of the aircraft should be verified with the path to follow. This is carried out by applying a yaw maneuver before switching the control mode. However, current drone control systems can become overloaded quickly as each task can be divided into different tasks, leading to an unmanageably large number of possible states.

As such current prior art solutions do not efficiently partition the problem to provide a granular solution using different levels of abstraction. Certain prior art methods for addressing this problem are in the works, but all known attempts are ill equipped to deal with simple configurations and complex behaviors simultaneously. Thus, for a simple configuration, stability and reachability analysis may be untenable with prior art approaches.

Accordingly, there is a need in the art for methods and systems that address the limited autonomy and processing capacity of prior art solutions by providing a state machine in the high level as disclosed herein.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide improved methods and systems for controllers.

It is another aspect of the disclosed embodiments to provide a method, system, and apparatus for autonomous vehicles, drones, or other such unmanned vehicles.

It is another aspect of the disclosed embodiments to provide methods, systems, and apparatuses for controlling autonomous vehicles, drones, or other such unmanned vehicles.

It is another aspect of the disclosed embodiments to provide methods, systems, and apparatuses comprising state machines for controlling autonomous vehicles, drones, or other such unmanned vehicles.

In the embodiments disclosed herein, a system, method, and apparatus for a state machine that operates at a high level and interacts with both high level and low level elements of a controller are disclosed. The current embodiments include a state machine with a plurality of operating states during which, tasks of the high level components are carried out and interact with the low level to gather information already processed and available. This is integrated into a model where the low level and the high level are decoupled.

For example, in an embodiment a system comprises a flight controller comprising: at least one processor, and a computer-usable medium embodying computer program code, the computer-usable medium capable of communicating with at least one processor, the computer program code comprising instructions executable by at least one processor and configured for controlling a vehicle, the flight controller further comprising: an obstacle avoidance module; a state machine; a data link module; and a control computer module.

In an embodiment, the state machine can have one of a plurality of states comprising: an initialization state, an arming state, a takeoff state, a mission state, a landing state, and teleoperation state. In an embodiment, the flight controller directs control of the vehicle according to a current state selected from the plurality of states associated with the state machine. In an embodiment, the vehicle undergoes initialization during the initialization state. In an embodiment, the vehicle transitions to the arming state after it has been initialized. In an embodiment, the vehicle is prepared for takeoff and the control computer module and obstacle avoidance module are notified the vehicle is ready for takeoff. In an embodiment, the control computer module, obstacle avoidance module, and flight controller guide the takeoff of the vehicle and the state machine is transitioned to the mission state. In an embodiment, upon completion of a mission, the state machine transitions to the land state; and the flight controller, control computer, and obstacle avoidance guide the vehicle to landing.

In an embodiment, upon fault detection in any of the initialization state, the arming state, the takeoff state, the mission state and the landing state, the state computer transitions to the teleoperation state to guide the vehicle to a safe landing.

In an embodiment, the vehicle comprises an autonomous aerial vehicle controlled by the flight controller. In an embodiment, the system comprises a ground station (GS) configured to provide remote control to the autonomous aerial vehicle.

In another embodiment, a method comprises enabling a vehicle for flight with a state machine configured to control the vehicle with a plurality of states, initializing a flight in an initialization state of the state machine, arming the vehicle for obstacle avoidance in an arming state of the state machine, directing the vehicle to take off in a takeoff state of the state machine, completing a missing with the vehicle in a mission state of the state machine, overriding other states for remote control of the vehicle by a ground station in a teleoperation state of the state machine, and landing the vehicle in a land state of the state machine.

In an embodiment of the method a flight controller directs control of the vehicle according to a current state selected from the plurality of states associated with the state machine. In an embodiment, the method comprises notifying a control computer module and an obstacle avoidance module when the vehicle is ready for takeoff. In an embodiment the method comprises checking for a fault condition and upon fault detection in any fault in the initialization state, the arming state, the takeoff state, the mission state and the landing state, the state computer transitions to the teleoperation state to guide the vehicle to a safe landing. In an embodiment of the method, the vehicle comprises an autonomous aerial vehicle controlled by the flight controller. In an embodiment of the method the ground station provides remote control to the autonomous aerial vehicle.

In another embodiment, a system for UAV control comprises a flight controller comprising: at least one processor and a computer-usable medium embodying computer program code, the computer-usable medium capable of communicating with at least one processor, the computer program code comprising instructions executable by at least one processor and configured for controlling a vehicle, the flight controller further comprising: an obstacle avoidance module; a state machine wherein the state machine can have one of a plurality of states comprising: an initialization state; an arming state; a takeoff state; a mission state; a landing state; and teleoperation state; a data link module; a control computer module; and a ground station configured to provide remote control to the autonomous aerial vehicle.

In an embodiment, the flight computer directs control of the vehicle according to a current state selected from the plurality of states associated with the state machine. In an embodiment, upon fault detection in any of the initialization state, the arming state, the takeoff state, the mission state and the landing state, the state computer transitions to the teleoperation state to guide the vehicle to a safe landing.

### BRIEF DESCRIPTION OF THE FIGURES

The accompanying figures, in which reference numerals refer to identical or functionally-similar elements throughout the separate views and which are incorporated in and form a part of the specification, further illustrate the embodiments and, together with the detailed description, serve to explain the embodiments disclosed herein.

FIG. 1 depicts a block diagram of a computer system which is implemented in accordance with the disclosed embodiments;

FIG. 2 depicts a graphical representation of a network of data-processing devices in which aspects of the present embodiments may be implemented;

FIG. 3 depicts a computer software system for directing the operation of the data-processing system depicted in FIG. 1, in accordance with an example embodiment;

FIG. 4 depicts a system diagram of an autonomous vehicle system, in accordance with the disclosed embodiments;

FIG. 5 depicts a flow chart of transitions between states in a state machine, in accordance with the disclosed embodiments;

FIG. 6 depicts a flow chart of operations associated with an initialization state, in accordance with the disclosed embodiments;

FIG. 7 depicts a flow chart of operations associated with an arming state, in accordance with the disclosed embodiments;

FIG. 8 depicts a flow chart of operations associated with a takeoff state, in accordance with the disclosed embodiments;

FIG. 9 depicts a flow chart of operations associated with a mission state, in accordance with the disclosed embodiments;

FIG. 10 depicts a flow chart of operations associated with a land state, in accordance with the disclosed embodiments;

FIG. 11 depicts a flow chart of operations associated with a teleoperation state, in accordance with the disclosed embodiments;

FIG. 12 depicts a system diagram of aspects of an autonomous vehicle system, in accordance with the disclosed embodiments;

FIG. 13 depicts a system diagram of an obstacle avoidance system, in accordance with the disclosed embodiments;

FIG. 14 depicts a system diagram of an alarm module, in accordance with the disclosed embodiments;

FIG. 15 depicts a system diagram of a ground station, in accordance with the disclosed embodiments; and

FIG. 16 depicts aspects of an unmanned autonomous vehicle (UAV), in accordance with the disclosed embodiments.

### DETAILED DESCRIPTION

The particular values and configurations discussed in the following non-limiting examples can be varied, and are cited merely to illustrate one or more embodiments and are not intended to limit the scope thereof.

Example embodiments will now be described more fully hereinafter, with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve the methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more items or terms, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope and concept of the invention as defined by the appended claims.

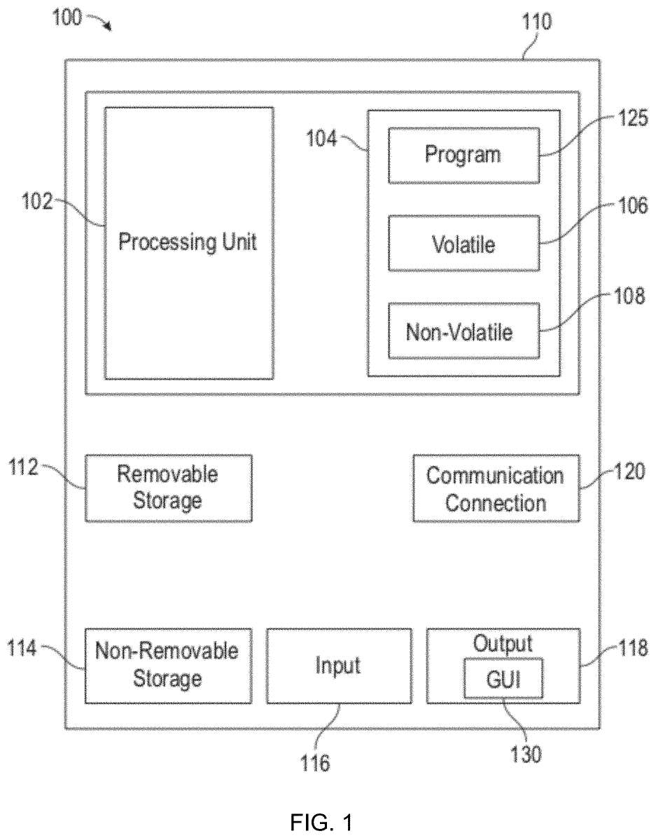

FIGS. 1-3 are provided as exemplary diagrams of data-processing environments in which embodiments of the present invention may be implemented. It should be appreciated that FIGS. 1-3 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

A block diagram of a computer system 100 that executes programming for implementing parts of the methods and systems disclosed herein is shown in FIG. 1. A computing device in the form of a computer 110 configured to interface with sensors, peripheral devices, and other elements disclosed herein may include one or more processing units 102, memory 104, removable storage 112, and non-removable storage 114. Memory 104 may include volatile memory 106 and non-volatile memory 108. Computer 110 may include or have access to a computing environment that includes a variety of transitory and non-transitory computer-readable media such as volatile memory 106 and non-volatile memory 108, removable storage 112 and non-removable storage 114. Computer storage includes, for example, random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions as well as data including image data.

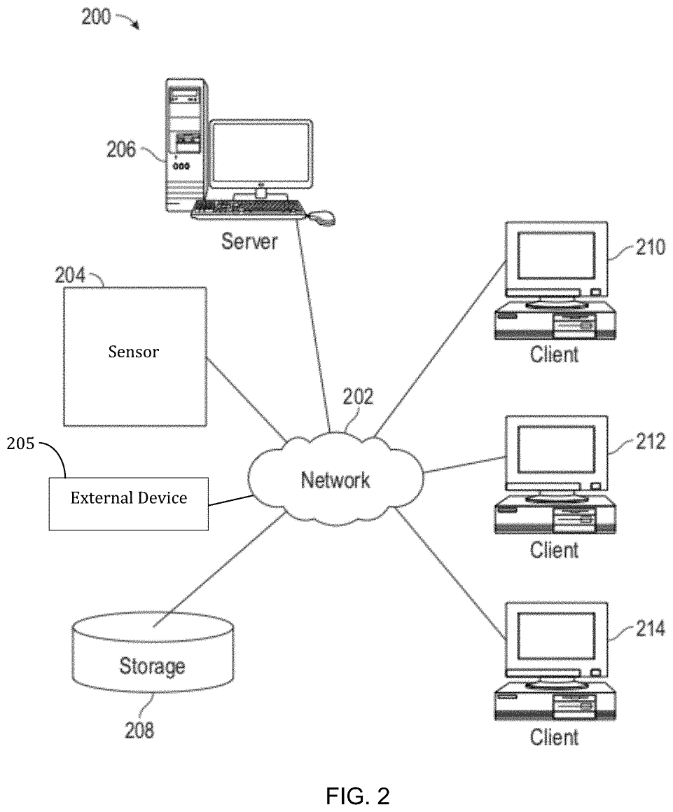

Computer 110 may include or have access to a computing environment that includes input 116, output 118, and a communication connection 120. The computer may operate in a networked environment using a communication connection 120 to connect to one or more remote computers, remote sensors, detection devices, hand-held devices, multi-function devices (MFDs), mobile devices, tablet devices, mobile phones, Smartphones, or other such devices. The remote computer may also include a personal computer (PC), server, router, network PC, RFID enabled device, a peer device or other common network node, or the like. The communication connection may include a Local Area Network (LAN), a Wide Area Network (WAN), Bluetooth connection, or other networks. This functionality is described more fully in the description associated with FIG. 2 below.

Output 118 is most commonly provided as a computer monitor, but may include any output device. Output 118 and/or input 116 may include a data collection apparatus associated with computer system 100. In addition, input 116, which commonly includes a computer keyboard and/or pointing device such as a computer mouse, computer trackpad, or the like, allows a user to select and instruct computer system 100. A user interface can be provided using output 118 and input 116. Output 118 may function as a display for displaying data and information for a user, and for interactively displaying a graphical user interface (GUI) 130.

Note that the term “GUI” generally refers to a type of environment that represents programs, files, options, and so forth by means of graphically displayed icons, menus, and dialog boxes on a computer monitor screen. A user can interact with the GUI to select and activate such options by directly touching the screen and/or pointing and clicking with a user input device 116 such as, for example, a pointing device such as a mouse and/or with a keyboard. A particular item can function in the same manner to the user in all applications because the GUI provides standard software routines (e.g., module 125) to handle these elements and report the user's actions. The GUI can further be used to display the electronic service image frames as discussed below.

Computer-readable instructions, for example, program module or node 125, which can be representative of other modules or nodes described herein, are stored on a computer-readable medium and are executable by the processing unit 102 of computer 110. Program module or node 125 may include a computer application. A hard drive, CD-ROM, RAM, Flash Memory, and a USB drive are just some examples of articles including a computer-readable medium.

FIG. 2 depicts a graphical representation of a network of data-processing systems 200 in which aspects of the present invention may be implemented. Network data-processing system 200 is a network of computers or other such devices such as mobile phones, smartphones, sensors, detection devices, and the like in which embodiments of the present invention may be implemented. Note that the system 200 can be implemented in the context of a software module such as program module 125. The system 200 includes a network 202 in communication with one or more clients 210, 212, and 214, and external device 205. The external device 205 can comprise a controller, flight computer, drone system, ground station (GS) 482, or other such component of a drone control system. Network 202 may also be in communication with one or more RFID and/or GPS enabled devices or sensors 204, servers 206, and storage 208. Network 202 is a medium that can be used to provide communications links between various devices and computers connected together within a networked data-processing system such as computer system 100. Network 202 may include connections such as wired communication links, wireless communication links of various types, fiber optic cables, quantum, or quantum encryption, or quantum teleportation networks, etc. Network 202 can communicate with one or more servers 206, one or more external devices such as RFID and/or GPS enabled device 204, and a memory storage unit such as, for example, memory or database 208. It should be understood that RFID and/or GPS enabled device 204 may be embodied as a mobile device, cell phone, tablet device, monitoring device, detector device, sensor microcontroller, controller, receiver, transceiver, or other such device.

In the depicted example, RFID and/or GPS enabled device 204, server 206, and clients 210, 212, and 214 connect to network 202 along with storage unit 208. Clients 210, 212, and 214 may be, for example, personal computers or network computers, handheld devices, mobile devices, tablet devices, smartphones, personal digital assistants, microcontrollers, recording devices, MFDs, etc. Computer system 100 depicted in FIG. 1 can be, for example, a client such as client 210 and/or 212.

Computer system 100 can also be implemented as a server such as server 206, depending upon design considerations. In the depicted example, server 206 provides data such as boot files, operating system images, applications, and application updates to clients 210, 212, and/or 214. Clients 210, 212, and 214 and RFID and/or GPS enabled device 204 are clients to server 206 in this example. Network data-processing system 200 may include additional servers, clients, and other devices not shown. Specifically, clients may connect to any member of a network of servers, which provide equivalent content.

In the depicted example, network data-processing system 200 is the Internet with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages. Of course, network data-processing system 200 may also be implemented as a number of different types of networks such as, for example, an intranet, a local area network (LAN), or a wide area network (WAN). FIGS. 1 and 2 are intended as examples and not as architectural limitations for different embodiments of the present invention.

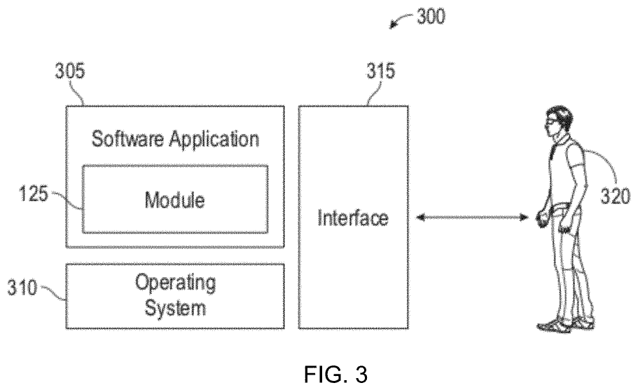

FIG. 3 illustrates a software system 300, which may be employed for directing the operation of the data-processing systems such as computer system 100 depicted in FIG. 1. Software application 305, may be stored in memory 104, on removable storage 112, or on non-removable storage 114 shown in FIG. 1, and generally includes and/or is associated with a kernel or operating system 310 and a shell or interface 315. One or more application programs, such as module(s) or node(s) 125, may be “loaded” (i.e., transferred from removable storage 114 into the memory 104) for execution by the data-processing system 100. The data-processing system 100 can receive user commands and data through user interface 315, which can include input 116 and output 118, accessible by a user 320. These inputs may then be acted upon by the computer system 100 in accordance with instructions from operating system 310 and/or software application 305 and any software module(s) 125 thereof.

Generally, program modules (e.g., module 125) can include, but are not limited to, routines, subroutines, software applications, programs, objects, components, data structures, etc., that perform particular tasks or implement particular abstract data types and instructions. Moreover, those skilled in the art will appreciate that elements of the disclosed methods and systems may be practiced with other computer system configurations such as, for example, hand-held devices, mobile phones, smartphones, tablet devices, multi-processor systems, printers, copiers, fax machines, multi-function devices, data networks, microprocessor-based or programmable consumer electronics, networked personal computers, minicomputers, mainframe computers, servers, medical equipment, medical devices, and the like.

Note that the term module or node as utilized herein may refer to a collection of routines and data structures that perform a particular task or implement a particular abstract data type. Modules may be composed of two parts: an interface, which lists the constants, data types, variables, and routines that can be accessed by other modules or routines; and an implementation, which is typically private (accessible only to that module), and which includes source code that actually implements the routines in the module. The term module may also simply refer to an application such as a computer program designed to assist in the performance of a specific task such as word processing, accounting, inventory management, etc., or a hardware component designed to equivalently assist in the performance of a task.

The interface 315 (e.g., a graphical user interface 130) can serve to display results, whereupon a user 320 may supply additional inputs or terminate a particular session. In some embodiments, operating system 310 and GUI 130 can be implemented in the context of a “windows” system. It can be appreciated, of course, that other types of systems are possible. For example, rather than a traditional “windows” system, other operation systems such as, for example, a real time operating system (RTOS) more commonly employed in wireless systems may also be employed with respect to operating system 310 and interface 315. The software application 305 can include, for example, module(s) 125, which can include instructions for carrying out steps or logical operations such as those shown and described herein.

The following description is presented with respect to embodiments of the present invention, which can be embodied in the context of, or require the use of a data-processing system such as computer system 100, in conjunction with program module 125, and data-processing system 200 and network 202 depicted in FIGS. 1-3. The present invention, however, is not limited to any particular application or any particular environment. Instead, those skilled in the art will find that the systems and methods of the present invention may be advantageously applied to a variety of system and application software including database management systems, word processors, and the like. Moreover, the present invention may be embodied on a variety of different platforms including Windows, Macintosh, UNIX, LINUX, Android, Arduino, and the like. Therefore, the descriptions of the exemplary embodiments, which follow, are for purposes of illustration and not considered a limitation.

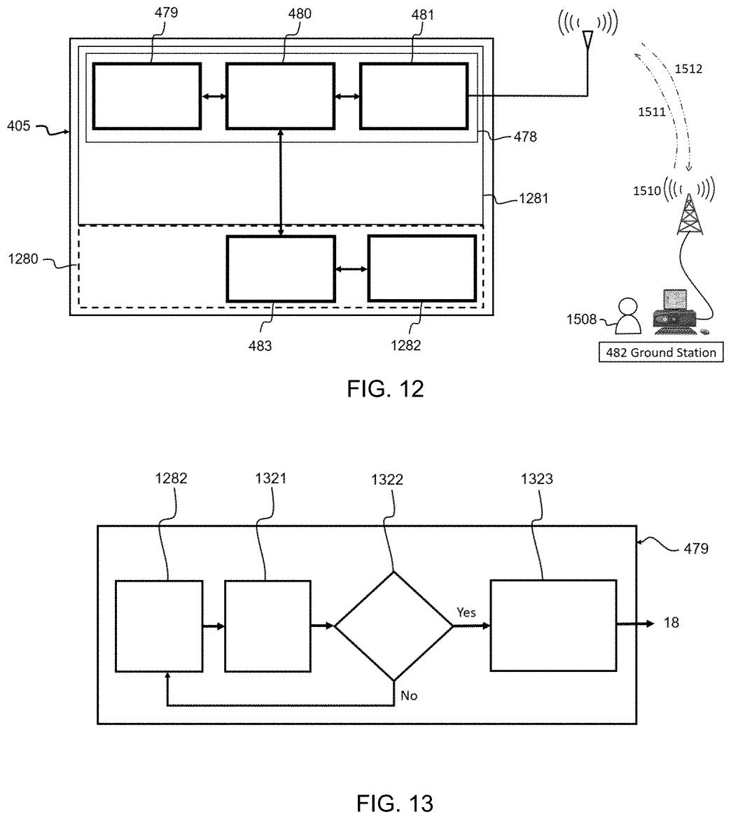

The embodiments, disclosed herein are generally configured to control autonomous vehicles. The term “autonomous vehicle” as used herein can be interchangeably used with the terms, “drone,” “aircraft,” “vehicle,” “UAV,” etc. The disclosed embodiments comprise two-levels, the low level 1280 and the high level 1281 as depicted in FIG. 12. The high level 1281 is provided by the autonomy payload in a flight computer (FC) 478. The FC 478 can comprise the obstacle avoidance (OA) module 479, the data link (DL) module 481 and the state machine 480. The low level 1280 can include input/output devices 1282 such as sensors and actuators and the modules that interact directly with them, i.e., the control computer (CC) 483. The low level 1280 control architecture of a UAV 405 can include a control and management architecture, configured to analyze the parameters provided to the CC 483. The CC 483 uses control laws associated with one or more actuators 1282 to provide mobility and stability to the UAV 405.

The disclosed embodiments improve autonomy and processing capacity by introducing a state machine in the high level. The hardware of the state machine can help increase the level of autonomy and perform processing onboard without increasing the computational burden in the low level.

The state machine of the disclosed embodiments can operate in the high level of the FC 478 to allow each module involved to carry out its own tasks. The state machine can control and monitor the high level and can communicate with the low level.

In certain embodiments, the low level and the high level are decoupled in the system architecture. The high level includes the OA module 479, the DL module 481 and the state machine 480. In this scheme, it is also necessary to communicate with the CC 483. Therefore, a state machine 480 in the high level allows decoupling the high level from the low level which helps increase the levels of autonomy and enables data-processing to be carried out onboard without the need to perform these processes at the low level.

Certain aspects of the disclosed embodiments include a state machine with a plurality of states and transitions. The state machine 480 may upload, store, and move the drone to any number of waypoints before returning home. The state machine 480 may be programmed to consider cooperation and coordination with multiple UAVs.

The disclosed method includes the initialization (I) state 505 which initially is absent of history and accepts all the parameters from the GS 482, necessary to perform the mission and to broadcast the remote ID.

According to the disclosed method, the arming or A state 510 initializes the arming of the drone and the obstacle avoidance module, then generates an output as an output to the next state. The takeoff or T state 515 takes care of the takeoff phase of the drone flight, and generates an output as an output to the next state. The mission or M state 520 is in charge of the flight-to mission and generates an output as an output to the next state. The land or L state 525 is in charge of the landing and generates an output for the next state or to terminate the mission.

The teleoperation or TO state 530 is a state that may take over the control of the drone from the rest of the states. According to the method, a return event from the TO state 530 may release the control to the state where the control was taken over. The TO state 530 receives commands from a pilot in the GS 482 and is able to manually guide the drone. The state machine may communicate status of the aircraft such as position, altitude, etc. The state machine may broadcast the remote ID and may communicate alarms to the GS 482, to the OA module 479 and to the CC module 483 to perform the proper maneuvers.

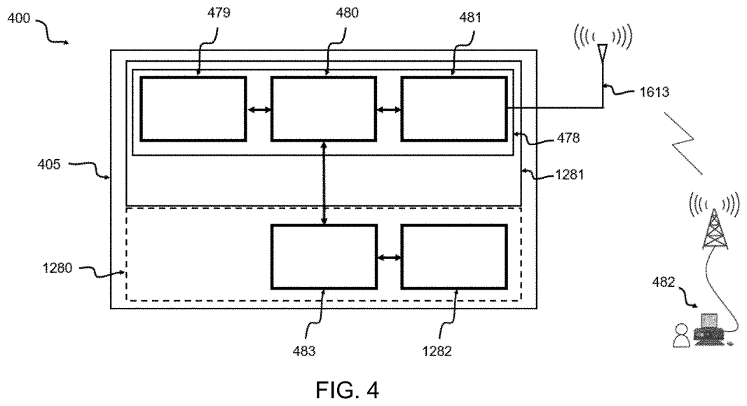

FIG. 4 illustrates a simplified block diagram of a system 400 with a state machine 480 for a flight controller or FC 478 used in an autonomous drone 405. The autonomous drone 405 can comprise an autonomous Unmanned Aerial Vehicle (UAV), Unmanned Aerial System (UAS) or other such unmanned vehicle.

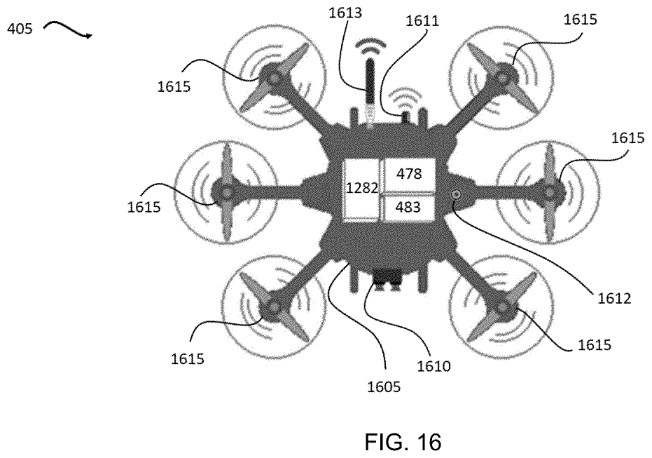

FIG. 16 illustrates additional aspects of a UAV 405 in accordance with the disclosed embodiments. A UAV 405, controlled by the GS 482, can comprise a UAV frame 1605, a plurality of motors 1615 with corresponding propellers, and a selection of sensors 1282. Sensors can include, for example, a depth camera 1610, a LiDAR 1611, at least one GPS unit 1612, a communication device with antenna 1613, a FC 478 and a CC 483. A mission can be executed by the UAV 405, while the UAV 405 remains in constant communication with the GS 482, which is receiving and transmitting data to the UAV 405.

Initially, the UAV 405 can receive a destination(s) or waypoints to visit. Next, the onboard computer can independently determine the proper route or path to follow to the destination, and then execute control to deliver the UAV 405 to the destination.

During flight, essential tasks must be carried out. These tasks can be divided into three groups, a) communication with the GS 482; b) stabilization of the aircraft and execution of a route; and c) surveillance and anti-collision.

The purpose of the first group of tasks can be to keep the GS 482 updated regarding the status, position, and alarm signals fired on board the UAV 405, as well as processing the information received from the GS 482.

The GS 482 is a land-based center that can provide a communications system 1505, with transmitter 1506 and receiver 1507, providing transmission and reception capabilities, and a computer 110 with a configuration to execute instructions stored in memory 104 in the form of programs to allow a pilot 1508, located on the ground, also called the ground pilot or ground controller, to communicate with, and control the UAV 405 and its payloads, via wireless telemetry 1510 as shown in FIG. 15. For example, the ground controller 1508 communicates with the drone 405, using the GS 482, via a wireless uplink 1511 and receives information from the drone 405 on a wireless downlink 1512. The flight parameters of the UAV 405 can be set by the ground controller 1508 for autonomous flight or for manual control of the drone 405. The GS 482 can display real time flight information. For example, real time flight information can include the performance of the drone 405, the status of the alarms, and the position and the altitude of the drone, among other things. The GS 482 can also send a number of commands to the UAV 405 such as destination and return to base. It can be thought of as a virtual cockpit, where a pilot 1508 on earth can take over control of the UAV 405 at any moment.

The aim of the second group of tasks can include, steering the aircraft 405 in the required direction to reach a waypoint by activating propulsion, servos, actuators, and other control systems associated with aircraft 405.

The purpose of the last group of tasks can be to avoid colliding with other moving or static objects.

Likewise, there are tasks to be carried out before, during, and after the flight. Before the flight, it may be necessary for the GS 482 to initialize the UAV 405 with the route or routes to follow. In addition, the FC 478 may initialize the modules and verify that sensors and actuators are operational, and inform the UAV 405 and GS 482 of the status of such modules, sensors, etc. before takeoff.

During takeoff, the FC 478 can guide the UAV 405 to the required altitude without compromising safety. In the course of the flight-to mission, the FC 478 may guide the UAV 405 safely to the desired destination, avoid obstacles and land safely. Afterward, the FC 478 can guide the UAV 405 to the desired location, or direct it to another destination. Moreover, alarm signals, localization, and altitude of the UAV 405 can be communicated to the GS 482. The ground pilot 1508 can take over control of the UAV 405 if manual control is required.

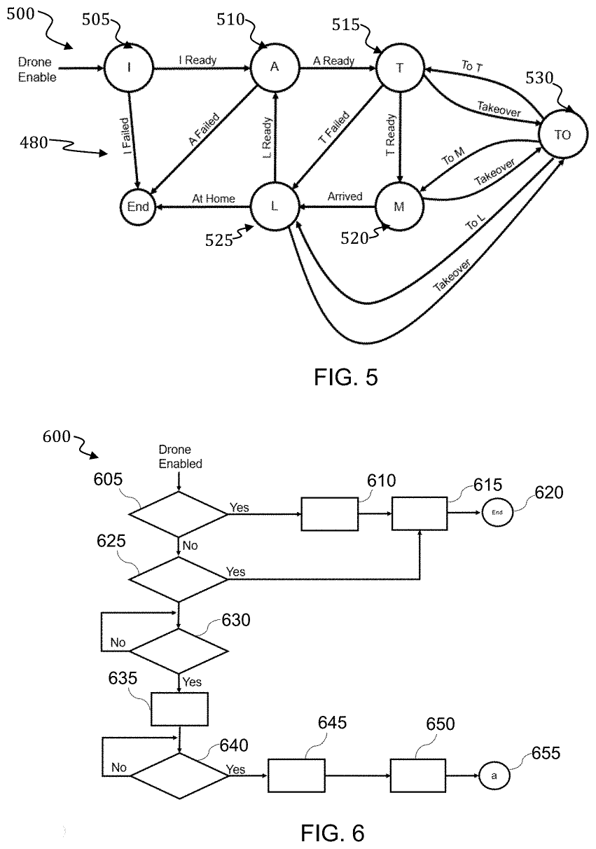

In certain embodiments, the system can make use of five states or phases for the UAV 405, which can include: Initialization (I) 505, Arming (A) 510, Takeoff (T) 5115, Mission (M) 520, Landing (L) 525, and TeleOperation (TO) 530, as illustrated in FIG. 5. A different group of tasks can be carried out depending on the state of the UAV 405. Hence, each group of tasks may be organized into the states of a state machine (SM) 480. Thus, a state machine 480 with behavior determined by a sequence of tasks may be included in the FC 478.

In an exemplary embodiment, the FC 478 provided in a drone 405 can operate autonomously and can be used to establish bi-directional communication with the base or GS 482. The destinations or waypoints and remote identification (ID) can be pre-programmed in the drone 405 or received from the GS 482. Notice that Remote ID can be carried out with a device that broadcasts identification and location information about the UAV 405 and its GS 482. This information can be received by other parties. These destinations can include the coordinates where the drone 405 has to land. In some cases, unforeseen circumstances may affect the destination after the aircraft has started the mission. For example, cancellations, detours, weather conditions, and air traffic all may change the required destination. Hence, one or more destinations may be changed in real time to alter the itinerary. In addition, commands from the GS 482, such as a return to home, may be processed and executed by the drone 405 to go back to the GS 482. At any moment during the flight, the GS 482 may be able to take over the control of the drone 405 to guide it manually by using teleoperation. Similarly, the FC 478 may send information about localization, alarm signals arising during the execution of the route, and the state of the flight.

For regulatory and safety reasons, the Federal Aviation Administration (FAA) requires an Obstacle Avoidance module (OA) 479. The OA module 479 can generate enough information to divert the drone 405 to avoid colliding with any object located in the flight path or during the takeoff and landing phases. Therefore, the OA module 479 needs to know the current state of the state machine 480. In addition, the OA module 479 may generate alarm signals to inform when any of its devices are malfunctioning.

Aspects of the OA module 479 are depicted in FIG. 13. The OA module 479 can include a LiDAR device, a video camera and/or another type of sensor 1282 to detect obstacles in the flight, as depicted in FIG. 12. The distances and collision trajectories to the obstacles or clusters of obstacles are determined in the measure distance block 1321. Then the trajectories can be adjusted in the decision block 1322. If necessary, the last operation is carried out in the safe direction calculator block 1323, where a direction to take the UAV 405 to a safe position can be calculated. The calculated direction is then passed to the CC module 483 to carry out the appropriate maneuver.

In certain embodiments, a CC module 483 may or may not be integrated into the FC 478. The CC 483 may gather information from sensors such as the GPS devices, infrared sensors, altimeters, accelerometers, gyroscopes, compasses, magnetometers, pressure sensors, inertial measurement units, and can send signals to actuators such as the electronic controllers and motors, to stabilize the drone 405 and direct the drone 405 to the waypoints. In addition, the control computer 483 can gather information from the GS 482 through the DL module 481 or from the OA module 479 to divert the path from the planned route in case of a route change or to execute evasion maneuvers in case of an obstacle. Moreover, the CC module 483 may generate alarm signals when a sensor or an actuator is malfunctioning. Similarly, when the battery is low, it may generate an alarm signal to inform the GS 482 to return the drone before the battery is completed depleted.

With the onboard data link module 481, the UAV 405 transmits 1512 and receives information 1511 to and from the GS 482, such as alarms fired on board, location, distance to a target, payload information, airspeed, and other such parameters. Further, to comply with FAA regulations, the drone 405 can be equipped with a remote ID module 413 to provide identification and location information that can be received by other parties. In addition, the DL module 481 can transmit video signals from cameras on board. Furthermore, the data link module 481 may receive parameters from the GS 482, such as commands to return to home and change of destination. In addition, this module may fire alarm signals when the communication between GS 482 and the UAV 405 is broken.

The FC 478 can keep the other modules informed of the phase or state the drone 405 is in, in such a way that the corresponding tasks, in each stage, are carried out properly. Furthermore, an alarm system may be useful to concentrate all the alarms coming from the different modules. Each alarm may be related to an emergency signal such as data link missing, low battery, broken video camera, broken GPS module, etc., to treat the alarms accordingly. The alarms can be divided into distress and urgency. A distress alarm refers to the fact that the drone 405 is severely damaged and immediate actions, such as parachute release, will be carried out. If a distress alarm is fired while the drone 405 is landed, takeoff will not be allowed. An urgency alarm fired during flight, such as data link broken, will cause the drone 405 return to base. Also, an urgency alarm, fired while the drone is landed, causes the drone 405 to stay on the ground. It should be noted that, as used herein the terms “phase” and “state” may be used interchangeably. For explanation purposes, the state machine 480 includes six basic states. However, more states and/or sub-states could be used and/or necessary in other embodiments. For example, a state to treat the alarm when a fault/failure/damage occurs in a sensor, an actuator, or a component 1282 and a sub state to constantly monitor the health status of the drone. Another state that can be added is a “land now state” that can search for a safe place to land, then jump to the “L” state to execute landing.

It should be appreciated that the integration of some or all modules shown in FIG. 4 are possible. The FC 478 may or may not include the control computer 483 in the same hardware. The FC 478 may include the OA 479, the state machine 480, and DL 481 modules.

As disclosed here, the states of the state machine 480 can include: Initialization (I) 505, Arming (A) 510, Takeoff (T) 515, Mission (M) 520, Landing (L) 525, and TeleOperation (TO) 530, integrated into a single state machine 480. FIG. 5 shows a schematic 500 of state machine unit 480. As illustrated in FIG. 5, at each state various checks or operations can be completed at which point the state advances or transitions to the next state.

In the disclosed method, one or more of the transitions fires a notification event. The method includes the I state 505 which initially is absent of history and accepts all the initial flight parameters from the GS 482, necessary to perform the mission and to broadcast the remote ID. In this method, during the A state 510 the drone is armed, the OA module 479 is initialized, then the state generates an output to signal the transition to the next state. The T state 515 takes care of the takeoff phase of the drone 405 and generates an output as an output to the next state. The M state 520 is in charge of the flight-to mission and generates an output as an output to the next state. The L state 525 is in charge of the landing and generates an output for the next state or to terminate the mission. The TO state 530 is a state that may take over the control of the drone 405 from the any of the remaining states. In the method, a return event from the TO state 530 can release the control to the state where the control was taken over. The TO state 530 receives commands from the ground pilot 1508 in the GS 482 and is able to manually guide the drone. The state machine 480 can communicate the status of the aircraft 405 such as position, altitude, etc. The state machine 480 can request the DL module 481 to broadcast the remote ID and can communicate alarms to the GS 482, to the OA module 479 and to the CC module 483 to perform the proper maneuvers.

In certain embodiments, a failure at state I 505 or state A 510 can immediately end all processing since the UAV 405 is not yet airborne. However, if the states I 505 and A 510 are completed successfully, the UAV 405 transitions to state T 515.

Upon takeoff at state T 515, an error will send the UAV 405 to a landing state L 525. This may necessitate a transition to state TO 530, where teleoperation of the drone 405 takes over. Successful takeoff transitions the UAV 405 to state M 520. At state M 520 the UAV 405 completes its mission. A failure during the M state 520 will send the UAV 405 to the TO state 530 where teleoperation can be used to land the drone (state L 525).

If the mission is completed successfully, the M 520 state transitions to the landing L 525 state. At this stage, the UAV is either returned to the arming A state 510, or the processing is completed.

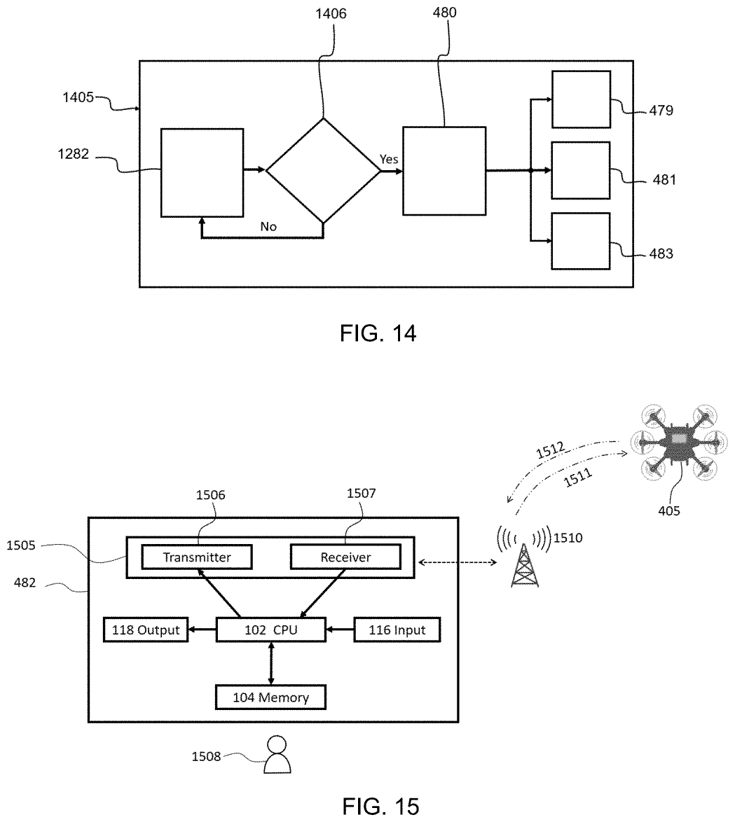

The embodiments rely on an alarm system used to identify various alarm conditions. FIG. 14 depicts a diagram of the alarm system 1405. The alarm system 1405 provides notifications to alert all the modules, including OA module 479, state machine 480, DL module 481, CC module 483, about a fault/failure/damage in a sensor, an actuator, or a component 1282. Typically, the signals generated by a plurality of sensors, devices, and subsystems 1282 are analyzed and compared at 1406 to their normal values or ranges. If any signal is out of range, an alarm is fired and the state machine 480 is notified, which in turn, can inform the GS 482 via the DL module 481, notify the alarm to the OA module 479, and the CC module 483 to carry out the appropriate maneuver. An example of alarm would be a battery unit sending value of a signal that represents the energy remaining of the batteries. The alarm system provides notification to alert the modules including OA module 479, DL module 481, and CC module 483, via the state machine 480 when the remaining energy drops below a predetermined value.

FIG. 6 illustrates a flow chart of operations 600 of the I state 505. Initially, when the drone 405 is at the GS 482 and enabled, the state machine 480 transitions to the I state 505. The alarm system can be tested for missing data links, low batteries, etc. If an alarm is fired as shown at 605, the state I can inform the GS 482 about the situation at block 610. If the output signal fails at 615 the process of the state machine 480 ends at 620. In the same way, if a cancellation command is received as shown at 625 from GS 482, the state I 505 can output that the signal I failed at 615 and the process of the state machine 480 ends at 620.

If all alarms are normal at 605 and no cancellation code at 610 is received, then the state machine 480 waits at step 630 until the flight parameters are received from the GS 482 at step 635. These parameters can include remote ID, waypoints, and cruise altitude, along with other flight or mission parameters. Next, the state machine 480 waits until receiving a ready signal 640 from the GS 482. The state machine informs the GS 482 at step 645, the CC module 483, and the OA module 479 about the transition to the A state 510 and outputs that the I state 505 is ready at 650. Finally, the transition 655 occurs to the A state 510.

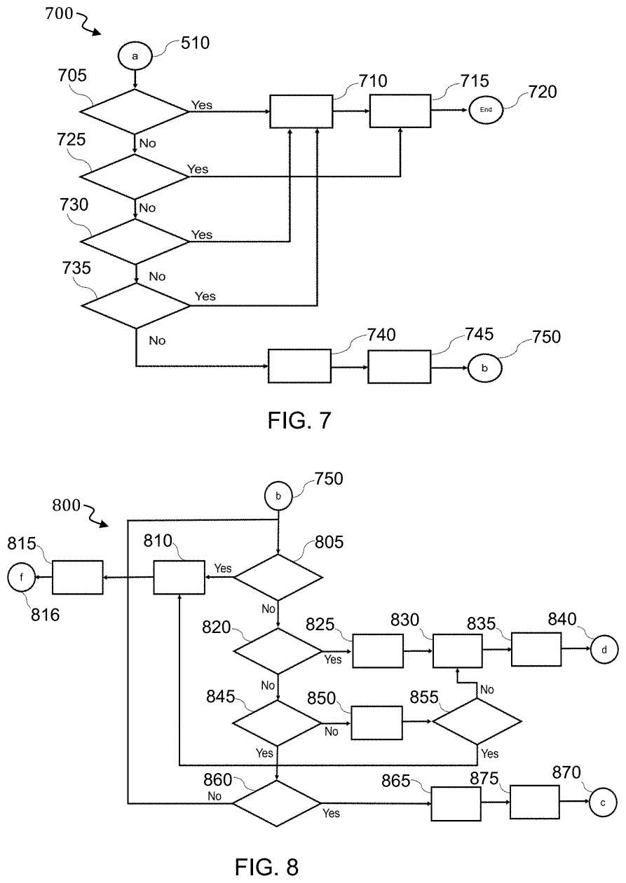

FIG. 7 shows a flow chart of the operational method 700 associated with A state 510. Initially, the alarm system is inspected at step 705. If an alarm is fired, the state A 510 informs the GS 482 about the situation at step 710, and an output signal is provided that A state 510 failed at 715, and a stop is issued at 720 to the state machine 480. If a cancellation command is received from GS 482, state A 510 outputs a signal that A state failed at 715 and a stop is issued at 720 to the state machine 480.

If the alarm system is normal at 705 and no cancellation command is received at 725, the state machine 480 waits for the ready signal from the CC 483 and the OA 479 modules. If a fault occurs at 730 in the CC module 483 or if a fault is received from the OA module 479 at decision block 735, the state A 510 can inform the GS 482 about the situation at 710, and can output that the state A 510 failed at step 715 and issue a stop to the state machine 480 at 720. Otherwise, the state machine informs the GS 482 at step 740, that the CC module 483 and the OA module 479 are prepared to transition to the T state 515 and outputs the signal that state A 510 is ready as shown at block 745. Finally, the transition occurs at step 750.

FIG. 8 shows a flow chart of operational steps in the method 800 of the T state 515, as it transitions from the A state 510 at 750. If the GS 482 requests takeover of control of the aircraft 405 at step 805, the state machine informs the CC module 483 and the OA module 479 at step 810 about the transition 816 to the TO state 530, and outputs the signal for takeover at 815. Next, the state machine 480 performs state transition to the TO state 530. Otherwise, if any alarm is fired at step 820, the state machine 480 can inform the GS 482 about the situation at step 825, and can output a signal indicating state T 515 failed at 830 and inform the CC module 483 and the OA module 479 at step 835 about the transition 840 to the L state 525. Next, a transition is queued to guide the drone 405 to land safely.

If no alarm is fired, but the aircraft 405 is not gaining altitude at step 845, the GS 482 may be informed at 850 of this situation. If the GS 482 requests aircraft control at step 855, the state machine 480 informs the CC module 483 and the OA module 479 at step 810 about the transition 816 to the TO state 530 and outputs a signal takeover at 815. Following, the state machine 480 performs the state transition 816 to the TO state 530.

Otherwise, the state machine 480 can output a signal that state T 515 failed at step 850 and can inform the CC module 483 and the OA module 479 at step 835 about the transition 840 to the L state 525. Once the transition occurs at step 840 the system attempts to safely land the drone 405.

If the drone 405 is gaining altitude at step 860 and has not reached the cruise altitude, the state T 515 starts over again. Otherwise, the state machine 480 informs the GS 482, the CC module 483, and the OA module 479 about the transition 870 to the M state 520 and outputs a signal to transition 870 from T state 515. Then, the state machine 480 performs state transition 870 to the M state 520.

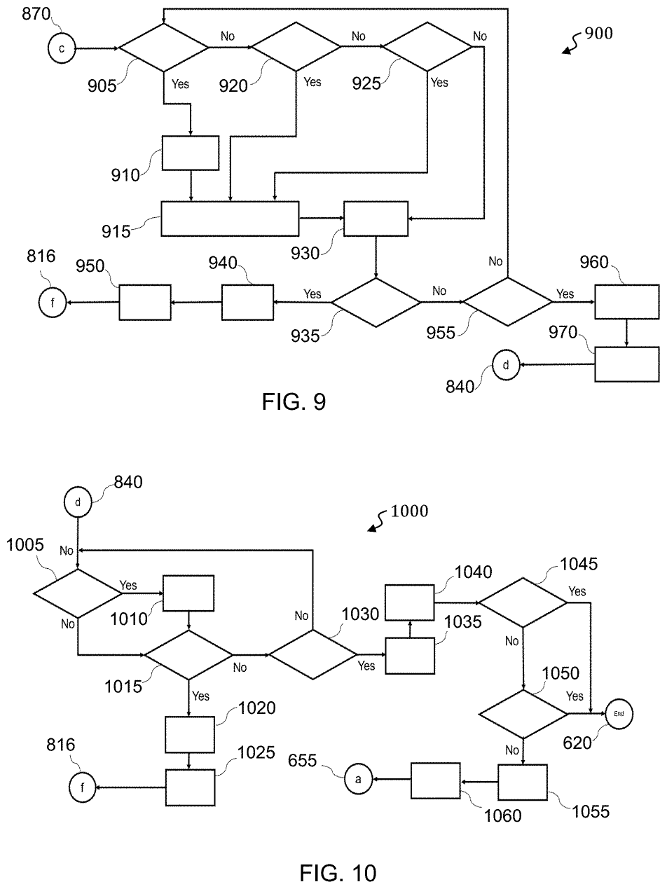

FIG. 9 shows a flow chart of operational steps in method 900 associated with the M state 520. The M state 520 operates during the flight-to mission. Initially, if an alarm is fired as shown at 905, the GS 482 is informed at step 910. The CC module 483 is also informed to execute the maneuver to return to home at step 915. In addition, if a return to home command 920 or a change in destination command 925 is received from the GS 482, the CC module 483 can be informed at step 915 to execute the corresponding maneuvers necessary to return the drone 405 home. Then, the status of the aircraft (altitude, global position, speed) can be transmitted to the GS 482 at step 930. If necessary, the state machine 480 at step 935 can inform the GS 482 and the CC module 483, and the obstacle avoidance module 479 at 940, about the transition 816 to the TO state 530 and may output the signal takeover at 950. Finally, the transition 816 to the TO state 530 can be executed.

If the destination has been reached at 955, the state machine 480 informs the GS 482, the CC module 483, and the OA module 479 at step 960 of the transition 840 to the L state 525 and outputs a signal indicating arrival at 970. Following, the state machine 480 performs state transition 840 to the L state 525.

FIG. 10 shows a flow chart of operational steps associated with a method 1000 for the L state 525. The L state 525 controls landing operations. Initially, if an alarm is fired at 1005, the GS 482 is informed at 1010. If necessary, GS 482 can request aircraft control as shown at 1015. Then, the state machine 480 can inform the GS 482, the CC module 483, and the OA module 479 at step 1020 of the transition 816 to the TO state 530 and may output the signal takeover at 1025. Then, the state machine can transition 816 to the TO state 530.

The process can be repeated if no request for takeover is received from the GS 482 and the aircraft 405 has not landed yet as shown at 1030. When the aircraft 405 has landed, the CC module 483 can be informed to disarm the drone 405 at step 1035. In addition, GS 482 and OA module 479 can be informed at step 1040 that the aircraft has landed and disarmed. Next, if the L state 525 was triggered by a T state 515 failure signal at 1045, the state machine 480 stops as shown at step 620. Finally, if the aircraft is landed at home as shown at 1050, the state machine 480 also stops at 620. Otherwise, the state machine 480 informs the GS 482, the CC module 483, and the OA module 479 at step 1055 about a new transition 655 to the A state 510 and outputs a signal that state L 525 is ready at step 1060, and the state machine 480 performs state transition 655 to the A state 510.

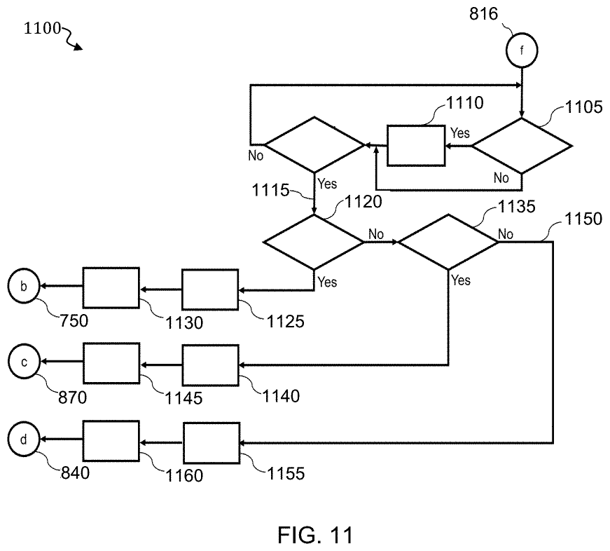

FIG. 11 shows a flow chart of operational steps 1100 associated with the TO state 530. The transition 816 into this state may be triggered by a takeover signal from states T 515, M 520, or L 525. If any alarm is fired at step 1105, the state machine may inform the GS 482 about the situation at 1110. This can be repeated whenever the TO state 530 continues at step 1110. When the GS 482 releases control at step 1115, the control is returned to the state where the transition was originated. For example, if the transition 816 was triggered by the T state 515 at step 1120, the TO state 530 indicates the transition to the T state 515 at 1125 and outputs a signal to transition to the T state 515 at step 1130. Notice that an alarm can be fired whenever the drone 405 gets stuck or gets lost in a place. For example, in the case of a lost GPS signal during flight, the state machine 480 informs the GS 482 of the situation, then the GS 482 can request to take over control and the state machine 480 transitions to the TO state 530.

Next, the state machine 480 performs state transition 750 to the T state 515. If the transition at step 1135 was initiated in the M state 520, the TO state 530 sends a notification at 1140 about the transition 870 to the M state 520 and outputs the signal to the M state 520 at 1145. Next, the state machine 480 performs state transition 870 to the M state 520. If the transition at 1150 was initiated in the L state 525, the TO state 530 sends a notification at 1155 about the transition to the T state 515 and outputs the signal to the M state 520 at 1160. The state machine 480 performs transition 840 to the M state 520.

It should be appreciated that the disclosed system architecture decouples the low level from the high level control of the aircraft. The low level is considered the CC module 483, which can include the autopilot and avionics and the related controller hardware, autonomous operation, and/or mission computer. The high level involves obstacle detection and avoidance, path planning, and communication with the GS 482.

The high level can also be the FC 478. At the high level, it is necessary for the UAV 405 to have a behavior in which all the components and tasks can be reusable. This requires that the components be interconnected in an orderly way. Thus, the disclosed embodiments include a state machine that represents the current state of the mission to order the high level tasks.

The current embodiments differ from previous systems in that the state machine includes a plurality of states to operate, during which tasks of the high level components are carried out and interact with the low level only to gather information already processed and available. This is integrated into a model where the low level and the high level are decoupled.

The disclosed embodiments solve the problem of limited autonomy and processing capacity by introducing a state machine in the high level. The hardware of the state machine 480 help increase the levels of autonomy and perform processing onboard without increasing the computational burden in the low level.

The state machine of the present embodiments may thus operate in the high level of the FC 478 to allow each module to perform its own tasks. The state machine 480 can take care of the high level and can communicate with the low level.

In certain embodiments, the low level and the high level are decoupled in the system architecture. The high level includes the OA module 479, the DL module 481, and the state machine 480. In this scheme, it is also necessary to communicate with the CC 483. Therefore, a state machine in the high level allows decoupling the high level from the low level which helps increase the levels of autonomy and enables data-processing to be carried out on board without the need to perform these processes at the low level.

The state machine 480 can include a plurality of states and transitions. The state machine 480 can execute any number of waypoints before returning home. In further embodiments, cooperation and coordination of multiple UAVs 405 is possible if the states are programmed accordingly. This can save time when using multiple aircrafts 405. In addition, the versatility of the state machine 480 can accommodate a team of heterogeneous aircrafts 405; that is, aerial vehicles 405 with different characteristics specialized in different roles. This will reduce costs by having multiple low-cost vehicles instead of one expensive vehicle.

Based on the foregoing, it can be appreciated that a number of embodiments, preferred and alternative, are disclosed herein. For example, in an embodiment a system comprises a FC 478 comprising: at least one processor, and a computer-usable medium embodying computer program code, the computer-usable medium capable of communicating with at least one processor, the computer program code comprising instructions executable by at least one processor and configured for controlling a vehicle, the flight controller further comprising: an OA module 479; a state machine 480; a DL module 481; and a CC module 483.

In an embodiment, the state machine 480 can have one of a plurality of states comprising: an initialization state 505, an arming state 510, a takeoff state 515, a mission state 520, a landing state 525, and teleoperation state 530. In an embodiment, the flight controller directs control of the vehicle 405 according to a current state selected from the plurality of states associated with the state machine 480. In an embodiment, the vehicle 405 undergoes initialization during the initialization state. In an embodiment, the vehicle transitions to the arming state 510 after it has been initialized. In an embodiment, the vehicle 405 is prepared for takeoff and the CC module 483 and OA module 479 are notified the vehicle is ready for takeoff. In an embodiment, the control computer module, OA module 479, and flight controller guide the takeoff of the vehicle 405 and the state machine 480 is transitioned to the mission state. In an embodiment, upon completion of a mission, the state machine 480 transitions to the land state 525; and the FC 478, the CC module 483, and OA module 479 guide the vehicle 405 to landing.

In an embodiment, upon fault detection in any of the takeoff state 515, the mission state 520 and the landing state 525, the state machine 480 transitions to the teleoperation state 530 to guide the vehicle to a safe landing.

In an embodiment, the vehicle comprises an autonomous aerial vehicle 405 controlled by the flight controller. In an embodiment the system comprises a GS 482 configured to provide remote control to the autonomous aerial vehicle 405.

In another embodiment, a method comprises enabling a vehicle 405 for flight with a state machine 480 configured to control the vehicle 405 with a plurality of states, initializing a flight in an initialization state 505 of the state machine 480, arming the vehicle for obstacle avoidance in an arming state 510 of the state machine 480, directing the vehicle to take off in a takeoff state 515 of the state machine 480, completing a missing with the vehicle 405 in a mission state 520 of the state machine 480, overriding other states for remote control of the vehicle by a GS 482 in a teleoperation state 530 of the state machine 480, and landing the vehicle 405 in a land state 525 of the state machine 480.

In an embodiment of the method a flight controller directs control of the vehicle 405 according to a current state selected from the plurality of states associated with the state machine 480. In an embodiment, the method comprises notifying a CC module 483 and an OA module 479 when the vehicle 405 is ready for takeoff. In an embodiment the method comprises checking for a fault condition and upon fault detection in any fault in the initialization state 505, the arming state 510, the takeoff state 515, the mission state 520 and the landing state 525, the state machine 480 transitions to the teleoperation state 530 to guide the vehicle 405 to a safe landing. In an embodiment of the method the vehicle 405 comprises an autonomous aerial vehicle 405 controlled by the flight controller. In an embodiment of the method the GS 482 provides remote control to the autonomous aerial vehicle 405.

In another embodiment, a system for UAV 405 control comprises a flight controller comprising: at least one processor and a computer-usable medium embodying computer program code, the computer-usable medium capable of communicating with at least one processor, the computer program code comprising instructions executable by at least one processor and configured for controlling a vehicle, the FC 478 further comprising: an OA module 479; a state machine 480 wherein the state machine 480 can have one of a plurality of states comprising: an initialization state 505; an arming state 510; a takeoff state 515; a mission state 520; a landing state 525; and teleoperation state 530; a DL module 481; a CC module 483; and a GS 482 configured to communicate and provide remote control to the autonomous aerial vehicle 405.

In an embodiment, the FC 478 directs control of the vehicle according to a current state selected from the plurality of states associated with the state machine 480. In an embodiment, upon fault detection in any of the initialization state 505, the arming state 510, the takeoff state 515, the mission state 520 and the landing state 525, the state machine 480 transitions to the teleoperation state 530 to guide the vehicle 405 to a safe landing.

In certain embodiments, upon a stuck or lost alarm, during the takeoff state, the mission state or the landing state, the state machine informs the ground station, and the teleoperation state takes over control, upon fault detection in any of the initialization state and the arming state, the state machine informs the ground station of the fault, upon fault detection in any of the takeoff state, the mission state and the landing state, the state machine informs the ground station, the obstacle avoidance module, and the control computer module, and upon a distress alarm in the initialization state, the arming state, the takeoff state, the mission state and the landing state, the state machine informs the ground station, the obstacle avoidance module, and the control computer module.

It should be appreciated that variations of the above-disclosed and other features and functions, or alternatives thereof, may be desirably combined into many other different systems or applications. It should be understood that various presently unforeseen or unanticipated alternatives, modifications, variations, or improvements therein may be subsequently made by those skilled in the art which are also intended to be encompassed by the following claims.

What is claimed is:

1. A system comprising:
a flight computer comprising:
at least one processor; and
at least a computer-usable medium embodying computer program code, the computer-usable medium capable of communicating with at least one processor, the computer program code comprising instructions executable by at least one processor and configured for controlling a vehicle, the flight computer further comprising:
an obstacle avoidance module;
a state machine;
a data link module; and
a control computer module.

2. The system of claim 1 wherein the state machine can have one of a plurality of states comprising:
an initialization state;
an arming state;
a takeoff state;
a mission state;
a landing state; and
teleoperation state.

3. The system of claim 2 wherein the flight computer directs control of the vehicle according to a current state selected from the plurality of states associated with the state machine.

4. The system of claim 2 wherein the vehicle undergoes initialization during the initialization state.

5. The system of claim 4 wherein the vehicle transitions to the arming state after it has been initialized.

6. The system of claim 5 wherein:
the vehicle is prepared for takeoff; and
the control computer module and the obstacle avoidance module are notified that the vehicle is ready for takeoff.

7. The system of claim 6 wherein:
the control computer module, the obstacle avoidance module, and flight computer guide the takeoff of the vehicle; and
the state machine is transitioned to the mission state.

8. The system of claim 7 wherein:
upon completion of a mission, the state machine transitions to a land state; and
the flight computer, control computer module, and obstacle avoidance guide the vehicle to landing.

9. The system of claim 8 wherein:
upon fault detection in any of the initialization state, the arming state, the takeoff state, the mission state and the landing state, the state computer transitions to the teleoperation state to guide the vehicle to a safe landing.

10. The system of claim 1 wherein the vehicle comprises an autonomous aerial vehicle controlled by the flight computer.

11. The system of claim 10 further comprising:
a ground station configured to provide remote control to the autonomous aerial vehicle.

12. A method comprising:
enabling a vehicle for flight with a state machine configured to control the vehicle with a plurality of states;
initializing a flight in an initialization state of the state machine;
arming the vehicle for obstacle avoidance in an arming state of the state machine;
directing the vehicle to take off in a takeoff state of the state machine;
completing a mission with the vehicle in a mission state of the state machine;
overriding other states for remote control of the vehicle by a ground station in a teleoperation state of the state machine; and landing the vehicle in a land state of the state machine.

13. The method of claim 12 wherein a flight controller directs control of the vehicle according to a current state selected from the plurality of states associated with the state machine.

14. The method of claim 12 further comprising:
Notifying a control computer module and an obstacle avoidance module when the vehicle is ready for takeoff.

15. The method of claim 12 further comprising:
checking for a fault condition; and
upon fault detection during the takeoff state, the mission state, and/or the land state, the state computer transitions to the teleoperation state to guide the vehicle to a safe landing.

16. The method of claim 13 wherein the vehicle comprises an autonomous aerial vehicle controlled by the flight controller

17. The method of claim 12 wherein the ground station provides remote control to the autonomous aerial vehicle.

18. A system for UAV control comprising:
a flight computer comprising:
at least one processor; and
a computer-usable medium embodying computer program code, the computer-usable medium capable of communicating with at least one processor, the computer program code comprising instructions executable by at least one processor and configured for controlling a vehicle, the flight computer further comprising:
an obstacle avoidance module;
a state machine wherein the state machine can have one of a plurality of states comprising: an initialization state; an arming state; a takeoff state; a mission state; a landing state; and teleoperation state;
a data link module; and
a control computer module; and
a ground station configured to provide remote control to the autonomous aerial vehicle.

19. The system for UAV control of claim 18 wherein the flight controller directs control of the vehicle according to a current state selected from the plurality of states associated with the state machine.

20. The system for UAV control of claim 18 wherein:
upon a stuck or lost alarm, during the takeoff state, the mission state or the landing state, the state machine informs the ground station, and the teleoperation state takes over control;
upon fault detection in any of the initialization state and the arming state, the state machine informs the ground station of the fault;
upon fault detection in any of the takeoff state, the mission state and the landing state, the state machine informs the ground station, the obstacle avoidance module, and the control computer module; and
upon a distress alarm in the initialization state, the arming state, the takeoff state, the mission state and the landing state, the state machine informs the ground station, the obstacle avoidance module, and the control computer module.
